(19) United States
(12) Patent Application Publication
(10) Pub. No.: US 2015/0002255 A1
(43) Pub. Date: Jan. 1, 2015

(54) COMPOSITE, METHOD OF FORMING THE SAME, AND INDUCTOR MANUFACTURED USING THE SAME

(71) Applicant: SAMSUNG ELECTRO-MECHANICS CO., LTD., Suwon-si (KR)

(72) Inventors: Hak Kwan KIM, Suwon-si (KR); Sung Yong AN, Suwon-si (KR); Jae Yeong KIM, Suwon-si (KR); Jung Wook SEO, Suwon-si (KR)

(21) Appl. No.: 14/317,436

(22) Filed: Jun. 27, 2014

(30) Foreign Application Priority Data
Jun. 28, 2013 (KR) 10-2013-0075684

(51) Int. Cl. H01F 27/255; B22F 3/00; H01F 1/20

(52) U.S. Cl. CPC H01F 27/255; H01F 1/20; B22F 3/00; B22F 2301/35
USPC 336/233; 75/255; 75/252; 419/66; 419/65

(57) ABSTRACT

Provided is a composite for manufacturing a chip part for a high frequency, and the composite includes a magnetic powder having a relatively spherical shape, and a metal magnetic body particle having a relatively more amorphous shape than that of the magnetic powder and a lower hardness than that of the magnetic powder.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2013-0075684, entitled filed Jun. 28, 2013, which is hereby incorporated by reference in its entirety into this application.”

### BACKGROUND OF THE INVENTION

1. Field of the Invention

The present invention relates to a composite, a method of manufacturing the same, and an inductor manufactured using the same, and more particularly, a composite capable of improving a DC-bias property and an inductance property of an inductor, a method of manufacturing the same, and a power inductor for a high frequency of 1 MHz or more manufactured using the same.

2. Description of the Related Art

A deposition type power inductor is mainly used in a power circuit such as a DC-DC converter in a mobile electronic device, in particularly, has a property of suppressing magnetic saturation of an inductor in a material or a structure, and thus, used for high current. While the deposition type power inductor has a large variation in inductance according to current application in comparison with a winding type power inductor, the deposition type power conductor can satisfy a trend of recent electronic parts due to advantages in a compact and slim structure.

The deposition type power inductor is manufactured by depositing magnetic sheets on which internal electrodes are printed to form a device body, and forming an external electrode electrically connected to the internal electrode on both end surfaces of the device body. Here, generally, the magnetic sheets are formed of a composite containing a ferrite powder. In addition, in order to reduce a variation in inductance of an external current, a gap layer formed of a non-magnetic body may be inserted into the device body to interrupt a magnetic flux by the gap layer.

The power inductor uses a soft magnetic body having good reactivity even in a low magnetic field to implement a high inductance property, and a ferrite powder is used as the soft magnetic body. However, the power inductor using the soft magnetic body such as ferrite cannot easily implement a good DC-bias property due to limitation in material of a saturated magnetic flux density. Accordingly, in recent times, a technique of manufacturing a power inductor using a metal magnetic body powder having a high saturated magnetization value as a soft magnetic body is developed.

In general, since it is difficult to solely use the metal magnetic body powder, a composite mixed with a material such as resin, a binder, and so on, is manufactured and used. Here, since the property of the inductor can be improved as a filling rate of the metal magnetic body powder is increased, a technique capable of increasing the filling rate of the metal magnetic body powder is needed. Among these techniques, there is a technique of mixing different kinds of metal magnetic body powders having different sizes at a certain ratio. However, in this case, since a content of the binder should also be increased and a maximum filling density of the metal magnetic body powder cannot be easily realized to 70 wt % or more with respect to the entire weight of the composite, it is technically difficult to increase permeability to 35 or more using a power inductor material for a high frequency that can be used in a frequency band of 1 MHz or more.

### RELATED ART DOCUMENT

### Patent Document

Patent Document 1: Japanese Patent Application Laid-Open No. 2006-179621

### SUMMARY OF THE INVENTION

The present invention has been invented in order to overcome the above-described problems and it is, therefore, an object of the present invention to provide a composite for manufacturing a chip part capable of exhibiting high inductance property, permeability and Q value even in a frequency band of 1 MHz or more, and a method of forming the same.

It is another object of the present invention to provide an inductor capable of improving inductance, permeability and Q value even in a frequency band of 1 MHz or more using a metal having a good saturated magnetization value as a metal [symbol] magnetic body material.

It is still another object of the present invention to provide a composite capable of increasing a filling rate of a magnetic material with respect to a composite to have high permeability of 35 or more.

In accordance with one aspect of the present invention to achieve the object, there is provided a composite including a magnetic powder having a relatively spherical shape, and a metal magnetic body particle having a relatively more amorphous shape than that of the magnetic powder and a lower hardness than that of the magnetic powder.

In accordance with an embodiment of the present invention, the metal magnetic body particle may include a pure iron particle having a purity of 99% or more.

In accordance with an embodiment of the present invention, the metal magnetic body particle may include nanocrystalline pure iron.

In accordance with an embodiment of the present invention, the metal magnetic body particle may include: a pure iron particle; and an insulating film coated on a surface of the pure iron particle.

In accordance with an embodiment of the present invention, the insulating film may be a phosphate coating layer.

In accordance with an embodiment of the present invention, the magnetic powder may include an iron-based alloy particle and a ferrite particle, and the metal magnetic particle may have a particle size larger than that of the alloy particle and smaller than that of the ferrite particle.

In accordance with an embodiment of the present invention, the magnetic powder may include an alloy particle, and the metal magnetic particle may have a larger capacity than that of the alloy particle.

In accordance with an embodiment of the present invention, the magnetic powder may include: at least one iron-based alloy particle selected from Fe—Si, Fe—Al, Fe—N, Fe—C, Fe—B, Fe—Co, Fe—P, Fe—Ni—Co, Fe—Cr, Fe—Si—Al, Fe—Si—Cr, and Fe—Si—B—Cr; and a ferrite particle having a size smaller than that of the alloy particle.

In accordance with an embodiment of the present invention, the magnetic powder may include the iron-based alloy particle and the ferrite particle, the iron-based alloy particle may have a particle size of 15 to 20 μm, and the metal magnetic particle has a particle size of 1 to 5 μm.

In accordance with an embodiment of the present invention, filling rates of the magnetic powder and the metal magnetic body particle with respect to the composite may be 95 wt % or more.

In accordance with an embodiment of the present invention, the metal magnetic body particle may have a shape conforming to an empty space between the magnetic powders.

In accordance with an embodiment of the present invention, the composite may be used to manufacture a device body of a high frequency power inductor used at a frequency band of 1 MHz or more, and the magnetic powder may include: an iron-based alloy particle that contributes to permeability of the power inductor; and a ferrite particle that relatively contributes to a Q property in comparison with the iron-based alloy particle.

An inductor according to the present invention includes a device body manufactured using a composite that contains a magnetic material; an internal electrode disposed in the device body; and an external electrode configured to be electrically connected to the internal electrode at both external ends of the device body, wherein the magnetic material includes: a magnetic powder having a relatively spherical shape; and a metal magnetic body particle having a relatively more amorphous shape than that of the magnetic powder, and a lower hardness than that of the magnetic powder.

In accordance with an embodiment of the present invention, the metal magnetic body particle may include a pure iron particle.

In accordance with an embodiment of the present invention, the metal magnetic body particle may include a pure iron having a surface coated with an insulating film.

In accordance with an embodiment of the present invention, wherein the magnetic powder may include: an iron-based alloy particle having a larger size than that of the metal magnetic particle; and a ferrite particle having a smaller size than that of the metal magnetic particle.

In accordance with an embodiment of the present invention, the metal magnetic body particle may be deformed to conform to a space between the magnetic powders to be filled into the composite.

In accordance with an embodiment of the present invention, the inductor may be a power inductor used at a frequency band of 1 MHz or more, and the magnetic powder may include: an iron-based alloy particle that contributes to permeability of the power inductor; and a ferrite particle that relatively contributes to improvement of a Q property in comparison with the iron-based alloy particle.

In accordance with an embodiment of the present invention, the inductor may have a saturated current value (Isat value) property of 3.0 or more.

A method of forming a composite for manufacture of a chip part according to the present invention includes preparing magnetic powders having a relatively spherical shape; preparing a metal magnetic body particle having a lower hardness than that of the magnetic powder; and manufacturing a magnetic powder mixture by deforming the metal magnetic body particle to conform to a space generated by mixing of the magnetic powders to fill the space such that a filling rate of the metal magnetic body particle with respect to the composite, and mixing the magnetic powder and the metal magnetic body particle.

In accordance with an embodiment of the present invention, the magnetic powder and the metal magnetic body particle may be filled into the composite at a filling rate of 95 wt % or more.

In accordance with an embodiment of the present invention, preparing the magnetic powders may include: preparing an iron-based alloy particle; and preparing a ferrite particle, and manufacturing the magnetic powder may be performed such that weight ratio is increased in a sequence of the iron-based alloy particle, the metal magnetic body particle, and the ferrite particle.

In accordance with an embodiment of the present invention, preparing the magnetic powders may include: preparing an iron-based alloy particle; and preparing a ferrite particle.

In accordance with an embodiment of the present invention, preparing the magnetic powders may include: preparing an iron-based alloy particle; and preparing a ferrite particle, and preparing the metal magnetic body particle may include preparing a pure iron particle having a purity of 99% or more.

In accordance with an embodiment of the present invention, preparing the magnetic powders may include preparing an iron-based alloy particle having a particle size of 15 to 20 μm, and preparing the metal magnetic particle may include preparing a pure iron particle having a particle size of 1 to 5 μm.

In accordance with an embodiment of the present invention, the method may further include mixing the magnetic powder mixture with a binder.

In accordance with an embodiment of the present invention, the chip part may be a power inductor used at a frequency band of 1 MHz or more, and may have an Isat value of 3.0 or more.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing an inductor according to an embodiment of the present invention;

FIG. 2 is a view showing a magnetic sheet shown in FIG. 1; and

FIG. 3 is a view showing a unit magnetic particle structure of a composite according to an embodiment of the present invention.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

In addition, an embodiment described herein will be described with reference to exemplary cross-sectional views and/or plan views of the present invention. In the drawings, thicknesses of films and regions are exaggerated for effective description of technical description. Accordingly, shapes of exemplary views may be varied due to tolerance or the like. Accordingly, the embodiment of the present invention is not limited to the shown specific shape but may include variations generated due to a manufacturing process. For example, an etching region shown in a right angle may be rounded or may have a predetermined radius of curvature.

Hereinafter, a composite, a method of manufacturing the same, and an inductor manufactured using the same according to an embodiment of the present invention will be described in detail with reference to the accompanying drawings.

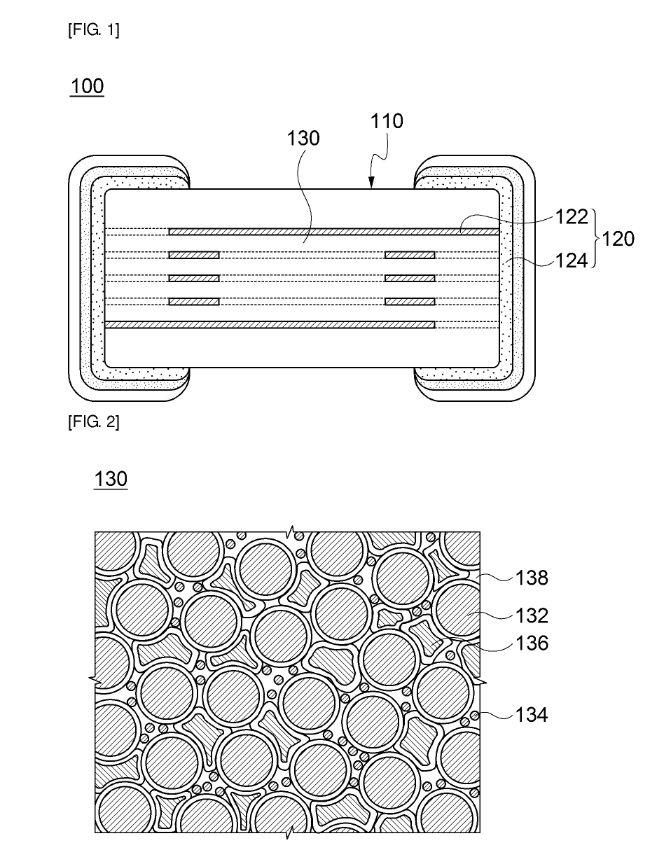

FIG. 1 is a view showing the inductor according to the embodiment of the present invention, and FIG. 2 is a view showing a magnetic sheet shown in FIG. 1.

Referring to FIGS. 1 and 2, an inductor 100 according to an embodiment of the present invention is a deposition type or thin film type power inductor used in a high frequency band of 1 MHz or more, which may include a device body 110, an electrode structure 120 installed at the device body 110, and so on.

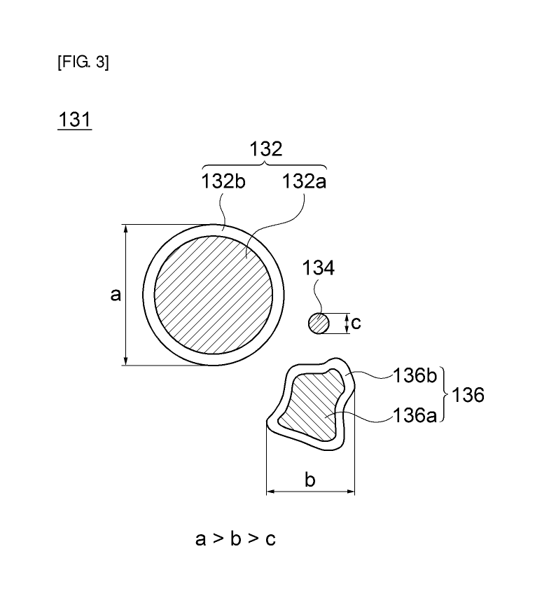

The device body 110 may have a multi-layered structure constituted by a plurality of magnetic sheets 130. Each of the magnetic sheets 130 may be manufactured by forming a sheet of a composite (131 of FIG. 3) formed of predetermined magnetic materials (132, 134 and 136 of FIG. 3) and a binder 138. The device body 110 may be manufactured by depositing and pressing an appropriate number of magnetic sheets 130 to manufacture a deposited body, and performing a plasticization process or the like on the deposited body. Here, the magnetic materials 132, 134 and 136 may include metal particles having a relatively higher saturated magnetization value than that of a ferrite powder. In this case, since an available frequency band of the inductor can be increased, the composite can also be used as a magnetic material of the inductor that can be used in a high frequency band of 1 MHz or more. Specific description of the composite 131 will be described below.

The electrode structure 120 may include an internal electrode 122 and an external electrode 124. The internal electrode 122 may be formed on the magnetic sheets 130 in the device body 110. The internal electrode 122 may be a circuit pattern formed of silver (Ag) or other metal materials. Here, the internal electrode 122 may be formed using a metal paste that can be conductively realized through low temperature plasticization.

The external electrode 124 may be provided to electrically connect the inductor 100 to an external electronic device (not shown). The external electrode 124 may be electrically connected to the internal electrode 122 and may be installed at each of both ends of the device body 110. The external electrode 124 may be constituted by a metal layer as an external terminal and plating layers formed of nickel (Ni) or tin (Sn) formed by performing a plating process on the metal layer.

Meanwhile, the inductor 100 having the above-mentioned structure may have an Isat value of 3.0 or more. More specifically, there is a DC current value Isat, which is one of major properties of the power inductor, at a point where inductance of the inductor is reduced by 30% of an initial value according to application of the direct current. The Isat value is generally in proportion to a saturated magnetization value (Ms value) of the magnetic material itself. In general, when the device body of the inductor is constituted by only the ferrite powder, since the Isat is low due to a low saturated magnetization value property of the ferrite material itself, it is technically difficult to manufacture the inductor that can be used at a large current. However, since the inductor 100 includes metal particles having relatively high saturated magnetization values as the magnetic materials 132, 134 and 136, it is possible to manufacture the inductor that can be used at a large current.

In order to implement the above-mentioned inductor properties, the metal particles may include iron (Fe)-based metal particles. In comparison with the ferrite powder composed through a general calcination reaction process in a spinel shape, the saturated magnetization value of the Fe metal is about 218 (emu/g), which is about three times. Referring to Table 1, which is described below, when Fe is contained in a metal-containing composite to 99 wt % or more, it is known that the saturated magnetization value can be obtained to 192 (emu/g) or more. In this case, machinability of the composite may be decreased, and electrical properties may not be secured. Accordingly, use of various types of Fe-based alloys may be one alternative. Here, in the case of an iron-based alloy particle, it is confirmed that the saturated magnetization value (Ms) can be secured to 150 (emu/g) or more when the Fe content is about 50 wt % or more. While not represented in Table 1, it is confirmed that the saturated magnetization value (Ms) is reduced to 100 (emu/g) or less when the Fe content is about 50 wt % or less.

TABLE 1

| | | Saturated |
|---|---|---|
| No. | Type of metal magnetic body | magnetization value(Ms) |
| 1 | Fe (99 wt % or more) | 192 (emu/g) |
| 2 | Fe-(3 to 10 wt %) Si-based | 172 (emu/g) |
| 3 | Fe—Si—Al Sendust based | 115 (emu/g) |
| 4 | Fe—Ni-based (Fe 50 wt % or more) | 150 (emu/g) |
| 5 | Fe—Si—Cr-based | 180 (emu/g) |
| 6 | Fe—Si—B—Cr amorphous based | 145 (emu/g) |

As described above, the inductor 100 according to the embodiment of the present invention can improve the inductance property and DC-bias property even at a high frequency of 1 MHz or more using the magnetic material including the metal magnetic body powder having a relatively higher saturated magnetization value than that of an ferrite oxide-based material as a material for manufacture of the device body 110. In this case, since the metal magnetic body powder 130 having a high saturated magnetization value is used as the magnetic body material, problems related to a decrease in inductance property and low direct current overlapping property due to the magnetic saturation can be solved, and there is no need to form a separate non-magnetic body gap layer. Accordingly, the inductor according to the present invention includes the device body manufactured using the magnetic material containing the metal particle having a high saturated magnetization value, and in comparison with the case in which only the ferrite material is used as the magnetic material, the high inductance property and DC-bias property can be exhibited even at a high frequency band of 1 MHz or more.

Next, the composite used for manufacturing the device body 110 of the above-mentioned inductor 100 will be described in detail. Here, overlapping description of the above-mentioned inductor 100 will be omitted or simplified.

FIG. 3 is a view showing a unit structure of the composite according to the embodiment of the present invention. Referring to FIGS. 1 to 3, the composite 131 according to the embodiment of the present invention is a composite for manufacture of the device body of the deposition type or thin film type power inductor used in a frequency band of 1 MHz or more, which may be composed of predetermined magnetic materials 132, 134 and 136, and the binder 138. The magnetic materials 132, 134 and 136 may be three or more kinds of magnetic body particles. For example, the magnetic materials are composed of magnetic powders 131 having a spherical or substantially spherical shape and a metal magnetic body powder 136 more amorphous than the magnetic powders, and the magnetic powders 131 may include an alloy particle 132 and a ferrite particle 134.

The alloy particle 132 may be a magnetic material having a relatively larger level of contribution to improvement of permeability of the inductor than that of the ferrite particle 134. The alloy particle 132 may be constituted by a core particle 132a and an oxide layer 132b formed on the core particle 132a. Iron-based alloy particle may be used as the core particle 132a. For example, at least one of Fe—Si, Fe—Al, Fe—N, Fe—C, Fe—B, Fe—Co, Fe—P, Fe—Ni—Co, Fe—Cr, Fe—Si—Al, Fe—Si—Cr, and Fe—Si—B—Cr may be used as the alloy particle 132. The oxide layer 132b may be a film formed by oxidizing the core particle 132a. Accordingly, the oxide layer 132b may be a film formed of a material such as FeO, Fe₂O₃, and Fe₃O₄ when the core particle 132a is the iron-based alloy particle. In addition, in order to maximize a magnetic property effect, the oxide layer may be a film using ferrite, which is partially substituted with a metal ion such as Ni, Cu, Zn, or the like.

The ferrite particle 134 may be a magnetic material having a relatively larger Q value of the inductor than that of the alloy particle 132. Various kinds of ferrite-based magnetic particles may be used as the ferrite particle 134. For example, Ni—Zn or Ni—Zn—Cu ferrite particle may be used as the ferrite particle 134. Here, Ni—Zn ferrite particle may be used as the ferrite particle 134, and alternatively, ferrite that selectively contains Fe2O3, NiO, ZnO and CuO may be used as the ferrite particle.

The metal magnetic body particle 136 may be a magnetic material that contributes to improvement of permeability and Q property of the inductor. In addition, the metal magnetic body particle 136 may be used as a material that largely increases a filling rate of the magnetic material with respect to the composite 131. For example, the metal magnetic body particle 136 may be formed of a pure iron particle 136a and an insulating film 136b formed on a surface of the pure iron particle 136a.

The pure iron particle 136a may be a pure iron particle having a purity of 99 wt %. The pure iron particle 136a may have a relatively lower hardness than that of the alloy particle 132 and the ferrite particle 134. Accordingly, the pure iron particle 136a may be deformed in a shape corresponding to an empty space between the spherical magnetic materials 132 and 134 except for the pure iron particle 136a to fill the empty space during the manufacturing process of the composite 131. The amorphous pure iron particle 136a can further increase the filling ratio of the magnetic material with respect to the composite 131.

The insulating film 136b may be a film formed of an oxide having a high electrical insulating property and good mechanical property. For example, the insulating film 136b may use phosphate or the like to improve a contribution level to the magnetic property of the inductor 100. As another example, Fe3O4, NiZnCu ferrite, NiZn ferrite, or the like, that may increase a contribution effect of the magnetic property may be used, in addition to the phosphate. Otherwise, an oxide such as MgO or Al2O3 may be used.

Meanwhile, the above-mentioned magnetic materials 132, 134 and 136 may have different sizes or capacities. More specifically, the alloy particle 132 may have a larger size than that of the ferrite particle 134. Since the alloy particle 132 and the ferrite particle 134 have a spherical shape or a substantially spherical shape, an average particle size of the alloy particle 132 may be larger than that of the ferrite particle 134. For example, the alloy particle 132 may be the iron-based alloy particle having D₅₀ of about 18 μm to 22 μm. When the D₅₀ of the alloy particle 132 is larger than about 22 μm, while it is advantageous from a viewpoint of permeability, a decrease in efficiency due to an increase in eddy current loss may occur. On the other hand, when the D₅₀ of the alloy particle 132 is less than about 18 μm, the permeability cannot arrive at a desired level to make it difficult to meet with an inductance property at a commercialization level. Meanwhile, the ferrite particle 134 can effectively fill the empty space caused by mixing of different kinds of powders as the size of the ferrite particle 134 is reduced.

In addition, the metal magnetic body particle 136 may have a size larger than that of the alloy particle 132 and smaller than that of the ferrite particle 134. For example, when the metal magnetic body particle 136 is the amorphous pure iron particle, the metal magnetic body particle 136 may have an average particle size or capacity smaller than that of the alloy particle 132. More specifically, the metal magnetic body particle 136 may have the average particle size of about 1 μm to 5 μm. When the average particle size of the metal magnetic body particle 136 is smaller than about 1 μm, a hysteresis loss due to an increase in particle boundary is increased. On the other hand, when the average particle size of the metal magnetic body particle 136 is larger than about 5 μm, efficiency may be largely decreased due to an abrupt increase in eddy current loss.

The binder 138 is provided to implement appropriate physical properties and insulating properties using the above-mentioned magnetic materials 132, 134 and 136 as the magnetic material of the device body of the inductor, and various kinds of insulating materials may be used as the binder 138. For example, the binder 138 may include a thermoplastic resin or a thermosetting resin, a hardener, a coupling agent, and so on. For example, thermoplastic resins such as polyethylene resin, polycarbonate resin, polyimide resin, polyacetylene resin, and so on, may be used as the binder 138. As another example, thermosetting resins such as epoxy resin, melanin resin, and so on, may be used as the binder 138.

As described above, the composite 131 according to the embodiment of the present invention may contain three kinds of magnetic materials constituted by the metal particles 132 and 136 having a relative high saturated magnetization value and satisfying high permeability, and the ferrite particle 134 that satisfies a relatively high frequency property and increase the filling rate of the magnetic material. Since the composite 131 can increase the filling rate of the magnetic material to 95 wt % or more and can increase the permeability, the high inductor properties can be implemented at a frequency band of 1 MHz or more. Accordingly, the composite according to the embodiment can be used as the magnetic material of the inductor that can satisfy the high inductance property and DC-bias property even at the frequency band of 1 MHz or more using the metal particle having a relatively higher saturated magnetization value and the ferrite particle that contributes to the permeability and the filling rate as the magnetic material, in comparison with only the two kinds of soft magnetic metal powders or ferrite powders are used as the magnetic material.

In addition, the composite 131 according to the embodiment of the present invention may have a composition in which magnetic body particles having different sizes of particles filled into a unit area, materials and coating layers are mixed, increasing the filling rate of the magnetic materials with respect to the composite 131. In particular, the magnetic materials may include the alloy particle 132, the ferrite particle 134 and the metal magnetic body particle 136, and the metal magnetic body particle 136 may use the pure iron particle 136a having a relatively low hardness and a relatively high saturated magnetization value. In this case, the metal magnetic body particle 136 can further increase the filling rate of the magnetic materials with respect to the composite 131 as the metal magnetic body particle 136 is deformed to conform to a shape of the space formed by mixing the alloy particle 132 and the ferrite particle 134. Accordingly, the composite according to the present invention may be used as the magnetic material of the inductor that can meet with the high inductance property and DC-bias property even at the frequency band of 1 MHz or more by increasing the filling rate of the magnetic materials with respect to the composite using the magnetic materials having different sizes of particles filled into the unit area, materials and coating layers.

### Embodiment

After a coarse powder having D₅₀=20 μm having a surface coated with Fe₃O₄, a nanocrystalline pure iron powder having D₅₀=5 μm, and NiZn ferrite having D₅₀=300 nm are mixed with a weight ratio of 7:2:1 are mixed, the mixture is pre-mixed using a ball mill to manufacture a mixed magnetic body powder. After the mixed magnetic body powder and ethylene propylene diene monomer (EPDM) applied to an organic high molecular matrix material are dispersed at a weight ratio 8:2, a green sheet having about 150 μm is manufactured using a doctor blade method. The green sheet is heated and pressed within a temperature range of about 60° C. using a hot roll press to manufacture a magnetic sheet formed of a resultant mixed powder. Ten magnetic sheets are stacked to manufacturing a toroidal core, and magnetic properties are finally estimated and represented as the following Table 2.

### Comparative Example 1

The magnetic sheet is manufactured using the ferrite powder as the magnetic material, toroidal cores having the same size are manufactured in a state in which the other conditions are equal to the above-mentioned embodiment, and magnetic properties are estimated and represented as the following Table 2.

### Comparative Example 2

The magnetic sheet is manufactured using the metal powder as the magnetic material, toroidal cores having the same size are manufactured in a state in which the other conditions are equal to the above-mentioned embodiment, and magnetic properties are estimated and represented as the following Table 2.

TABLE 2

| | | | Available | Filling | |
|---|---|---|---|---|---|
| | Inductance | Isat | frequency | rate | |
| Classification | (μH) | (A) | (MHz) | (%) | permeability |
| Embodiment 1 | 2.2 | 3.2 | 10 | 98 | 40 |
| Comparative | 2.2 | 1.3 | 10 | 98 | 120 |
| Example 1 | | | | | |
| Comparative | 2.2 | 2.1 | 3 | 92 | 30 |
| Example 2 | | | | | |

Referring to Table 2, it will be appreciated that, while a conventional ferrite powder like Comparative Example 1 has high permeability at an available frequency band, since a saturated current value (Isat value) of the material itself is too low, the powder cannot be easily used as the magnetic material of the inductor that satisfies high current properties, which are required in recent times. On the other hand, it will be appreciated that, like Comparative Example 2, while the metal powder can increase the saturated current value to 2 A or more, the powder cannot be used at the available frequency band to make it impossible to deal with the high frequency. However, Embodiment 1 shows that the saturated current value, the available frequency, and the filling rate are better than that of Comparative Examples 1 and 2. In particular, in Embodiment 1, it will be appreciated that the Isat value is 3.0 or more, and high properties can be exhibited in comparison with the case in which the ferrite powder or metal powder is solely used. This is because the pure iron particle can uniformly fill the empty space between the other magnetic materials to further increase the filling rate even when the metal powder having the high saturated current value and the ferrite particle contributing the permeability and the filling rate are simultaneously used.

As can be seen from the foregoing, the inductor according to the present invention can exhibit high inductance property and DC-bias property even at a frequency band of 1 MHz or more in comparison with the case in which only the ferrite material is used as the magnetic material by including the device body manufactured using the magnetic material containing the metal particle having the high saturated magnetization value.

The composite according to the embodiment can be used as the magnetic material of the inductor that can satisfy the high inductance property and DC-bias property even at the frequency band of 1 MHz or more in comparison with the case in which the two kinds of soft magnetic metal powders or ferrite powders are used as the magnetic material using the metal particle having the relatively high saturated magnetization value and the ferrite particle contributing the permeability and the filling rate as the magnetic material.

The composite according to the present invention can be used as the magnetic material of the inductor that can satisfy the high inductance property and DC-bias property even at the frequency band of 1 MHz or more by increasing the filling rate of the magnetic materials with respect to the composite using the magnetic materials having different sizes of particles filled into the unit area, materials, and coating layers.

The method of forming the composite according to the present invention can form the magnetic material of the inductor that can satisfy the high inductance property and DC-bias property even at the frequency band of 1 MHz or more by using the metal particle having the relatively high saturated magnetization value and the ferrite particle contributing the permeability and the filling rate in comparison with the case in which only the two kinds of soft magnetic metal powders or ferrite powders are used as the magnetic material.

The method of forming the composite according to the present invention can form the magnetic material of the inductor that can satisfy the high inductance property and DC-bias property even at the frequency band of 1 MHz or more by using the filling rate of the magnetic materials with respect to the composite using the magnetic materials having different sizes of particles filled into the unit area, materials, and coating layers.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A composite comprising:
a magnetic powder having a relatively spherical shape; and
a metal magnetic body particle having a relatively more amorphous shape than that of the magnetic powder and a lower hardness than that of the magnetic powder.

2. The composite according to claim 1, wherein the metal magnetic body particle comprises a pure iron particle having a purity of 99% or more.

3. The composite according to claim 1, wherein the metal magnetic body particle comprises nanocrystalline pure iron.

4. The composite according to claim 1, wherein the metal magnetic body particle comprises:
a pure iron particle; and
an insulating film coated on a surface of the pure iron particle.

5. The composite according to claim 4, wherein the insulating film is a phosphate coating layer.

6. The composite according to claim 1, wherein the magnetic powder comprises an iron-based alloy particle and a ferrite particle, and
the metal magnetic particle has a particle size larger than that of the alloy particle and smaller than that of the ferrite particle.

7. The composite according to claim 1, wherein the magnetic powder comprises an alloy particle, and
the metal magnetic particle has a larger capacity than that of the alloy particle.

8. The composite according to claim 1, wherein the magnetic powder comprises:
at least one iron-based alloy particle selected from Fe—Si, Fe—Al, Fe—N, Fe—C, Fe—B, Fe—Co, Fe—P, Fe—Ni—Co, Fe—Cr, Fe—Si—Al, Fe—Si—Cr, and Fe—Si—B—Cr; and
a ferrite particle having a size smaller than that of the alloy particle.

9. The composite according to claim 1, wherein the magnetic powder comprises the iron-based alloy particle and the ferrite particle,
the iron-based alloy particle has a particle size of 15 to 20 μm, and
the metal magnetic particle has a particle size of 1 to 5 μm.

10. The composite according to claim 1, wherein filling rates of the magnetic powder and the metal magnetic body particle with respect to the composite are 95 wt % or more.

11. The composite according to claim 1, wherein the metal magnetic body particle has a shape conforming to an empty space between the magnetic powders.

12. The composite according to claim 1, wherein the composite is used to manufacture a device body of a high frequency power inductor used at a frequency band of 1 MHz or more, and
the magnetic powder comprises:
an iron-based alloy particle that contributes to permeability of the power inductor; and
a ferrite particle that relatively contributes to a Q property in comparison with the iron-based alloy particle.

13. An inductor comprising:
a device body manufactured using a composite that contains a magnetic material;
an internal electrode disposed in the device body; and
an external electrode configured to be electrically connected to the internal electrode at both external ends of the device body,
wherein the magnetic material comprises:
a magnetic powder having a relatively spherical shape; and
a metal magnetic body particle having a relatively more amorphous shape than that of the magnetic powder, and a lower hardness than that of the magnetic powder.

14. The inductor according to claim 13, wherein the metal magnetic body particle comprises a pure iron particle.

15. The inductor according to claim 13, wherein the metal magnetic body particle comprises a pure iron having a surface coated with an insulating film.

16. The inductor according to claim 13, wherein the magnetic powder comprises:
an iron-based alloy particle having a larger size than that of the metal magnetic particle; and
a ferrite particle having a smaller size than that of the metal magnetic particle.

17. The inductor according to claim 13, wherein the metal magnetic body particle is deformed to conform to a space between the magnetic powders to be filled into the composite.

18. The inductor according to claim 13, wherein the inductor is a power inductor used at a frequency band of 1 MHz or more, and
the magnetic powder comprises:
an iron-based alloy particle that contributes to permeability of the power inductor; and
a ferrite particle that relatively contributes to improvement of a Q property in comparison with the iron-based alloy particle.

19. The inductor according to claim 13, wherein the inductor has a saturated current value (Isat value) property of 3.0 or more.

20. A method of manufacturing a composite for manufacture of a chip part, the method comprising:
preparing magnetic powders having a relatively spherical shape;
preparing a metal magnetic body particle having a lower hardness than that of the magnetic powder; and
manufacturing a magnetic powder mixture by deforming the metal magnetic body particle to conform to a space generated by mixing of the magnetic powders to fill the space such that a filling rate of the metal magnetic body particle with respect to the composite, and mixing the magnetic powder and the metal magnetic body particle.

21. The method of manufacturing the composite according to claim 20, wherein the magnetic powder and the metal magnetic body particle are filled into the composite at a filling rate of 95 wt % or more.

22. The method of manufacturing the composite according to claim 20, wherein preparing the magnetic powders comprises:
preparing an iron-based alloy particle; and
preparing a ferrite particle, and
manufacturing the magnetic powder is performed such that weight ratio is increased in a sequence of the iron-based alloy particle, the metal magnetic body particle, and the ferrite particle.

23. The method of manufacturing the composite according to claim 20, wherein preparing the magnetic powders comprises:
preparing an iron-based alloy particle; and
preparing a ferrite particle.

24. The method of manufacturing the composite according to claim 20, wherein preparing the magnetic powders comprises:
preparing an iron-based alloy particle; and
preparing a ferrite particle, and
preparing the metal magnetic body particle comprises preparing a pure iron particle having a purity of 99% or more.

25. The method of manufacturing the composite according to claim 20, wherein preparing the magnetic powders comprises preparing an iron-based alloy particle having a particle size of 15 to 20 μm, and
preparing the metal magnetic particle comprises preparing a pure iron particle having a particle size of 1 to 5 μm.

26. The method of manufacturing the composite according to claim 20, further comprising mixing the magnetic powder mixture with a binder.

27. The method of manufacturing the composite according to claim 20, wherein the chip part is a power inductor used at a frequency band of 1 MHz or more, and has an Isat value of 3.0 or more.
